(19) United States
(12) Patent Application Publication
(10) Pub. No.: US 2011/0120571 A1
(43) Pub. Date: May 26, 2011

(54) Liquid Filled Tap Handle

(76) Inventors: Heather J. Derge, Juneau, WI (US); Aaron W. Smith, Watertown, WI (US)

(21) Appl. No.: 12/953,061

(22) Filed: Nov. 23, 2010

Related U.S. Application Data
(60) Provisional application No. 61/264,089, filed on Nov. 24, 2009.

(51) Int. Cl. F16K 31/60

(52) U.S. Cl. 137/315.15

(57) ABSTRACT

A tap handle includes a chamber that can be filled with liquid, which may be colored to represent a beverage associated with the tap handle. The material of the handle may be transparent or semi-transparent, allowing a consumer to readily identify a characteristic of the beverage, such as whether it is a dark or light beer. The body of the handle may be formed in the shape of a bottle, a glass, or any other ornamental design. The body of the handle may also include an insert in the lower portion for connecting the handle onto the tap. Alternately, the body may be secured to a fitting that, in turn, connects to the tap. The chamber may also include particles that float to top of the liquid, such that the liquid inside the chamber resembles beer or any other liquid, such as soda, that can be dispensed via a tap.

### CROSS-REFERENCE TO RELATED APPLICATIONS

This application claims priority to U.S. provisional application Ser. No. 61/264,089, filed Nov. 24, 2009, the entire contents of which is incorporated herein by reference.

### BACKGROUND OF THE INVENTION

This application is directed to beverage tap handles and, more particularly, to a tap handle having a liquid filled chamber.

In many establishments that serve beverages, such as restaurants, sports bars, and taverns, it is common for a beer or soda tap handle to include some indicia identifying the brand of beverage associated with the tap handle. Initially, the indicia may simply have been in the form of the brand name of the beverage on a generic tap handle. Increasingly, however, beverage producers such as brewers have provided elaborate tap handles that are specially shaped or that include pictures and other objects reflective of the brand of the beverage with the intent of differentiating the beverage tap handle from a slew of beverage tap handles at the dispensing station of the establishment. As a result, a consumer, when viewing the various tap handles at the dispensing station can readily identify the selection of available beverages by viewing the tap handles at the dispensing station.

### SUMMARY OF THE INVENTION

The present invention provides a tap handle having a chamber that can be filled with liquid, which may be colored to represent a beverage associated with the tap handle. The material of the handle may be transparent or semi-transparent, allowing a consumer to readily identify a characteristic of the beverage, such as whether it is a dark or light beer. The body of the handle may be formed in the shape of a bottle, a glass, or any other ornamental design. The body of the handle may also include an insert in the lower portion for connecting the handle onto the tap. Alternately, the body may be secured to a base that, in turn, connects to the tap. The chamber may also include particles that float on top of the liquid and that resemble foam, such that the liquid inside the chamber resembles beer or any other liquid, such as soda, that can be dispensed via a tap.

According to a first embodiment of the present invention, a handle for a tap faucet includes a first housing defining a generally hollow cavity and includes an opening in communication with the cavity. A liquid is disposed within the hollow cavity, and a cover is connected to the first housing to seal the opening. A base is coupled to the first housing and configured to operably connect the first housing to the tap faucet. The handle may further include a plurality of floating particles disposed within the hollow cavity, which resemble foam. Thus, it is a feature of this invention that the tap handle provide a visual indication of the beverage dispensed by the tap faucet.

According to another aspect of the invention, the handle may also include a second housing defining a volume. Each of the first and second housings may be elongated, and the second housing is contained within the cavity of the first housing. An identifier may also be contained within the second housing indicating at least one of the beverage manufacturer or beverage brand name to be dispensed by the faucet. The handle may further include a recess formed at a first end of the cavity in the first housing and a tab extending from a first end of the second housing. The tab engages the recess to retain the second housing in alignment with the first housing. The second housing may also include a receiving member extending from a second end of the second housing and the cover may include an engaging member extending into the cavity. The engaging member operably engages the receiving member to further retain the second housing in alignment with the first housing.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWING(S)

Various exemplary embodiments of the subject matter disclosed herein are illustrated in the accompanying drawings in which like reference numerals represent like parts throughout, and in which:

FIG. 1 is a perspective view of an embodiment of the tap handle according to the present invention connected to a tap faucet;

FIG. 2 is a perspective view from the side and top of the tap handle of FIG. 1;

FIG. 3 is a top plan view of the tap handle of FIG. 2;

FIG. 4 is a side elevation view of the tap handle of FIG. 2;

FIG. 5 is a cross-sectional view of the tap handle of FIG. 2 taken at 5-5 as shown in FIG. 4;

FIG. 6 is a perspective view from the side and top of another embodiment of the tap handle according to the present invention;

FIG. 7 is a top plan view of the tap handle of FIG. 6;

FIG. 8 is a side elevation view of the tap handle of FIG. 6; and

FIG. 9 is a cross-sectional view of the tap handle of FIG. 6 taken at 9-9 as shown in FIG. 8.

In describing the representative embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

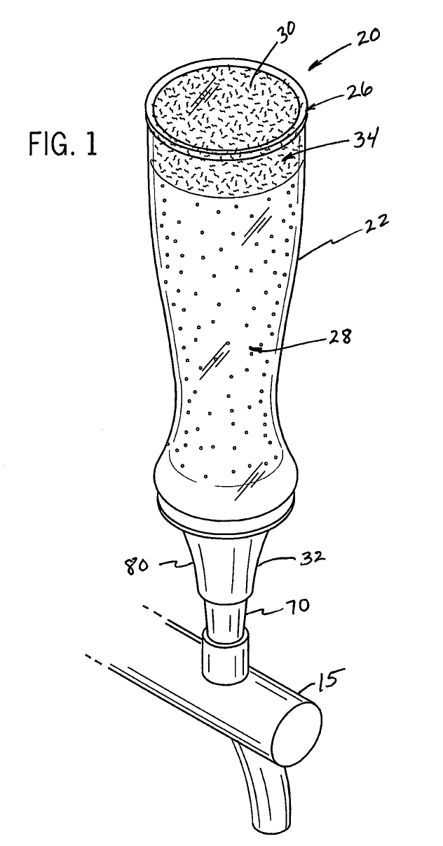

Specific embodiments of the present invention will now be further described by the following, non-limiting examples which will serve to illustrate various features of the invention. With reference to the drawing figures in which like reference numerals designate like parts throughout the disclosure, a representative embodiment of the present invention is shown in FIG. 1 as a tap handle 20 connected to a tap faucet 15.

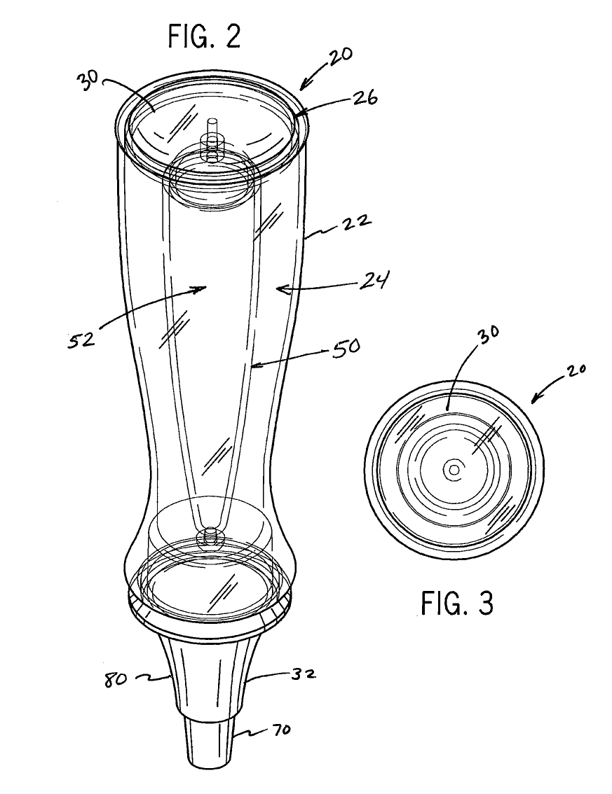

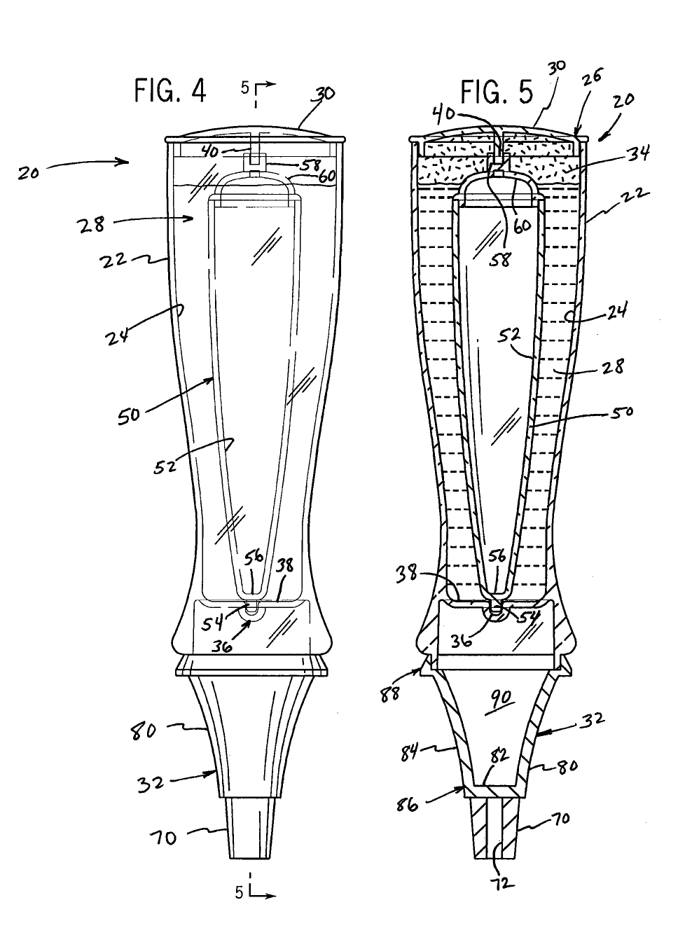

Referring initially to FIGS. 1-5, the tap handle 20 is connected to the tap faucet 15 from which a beverage is dispensed. The tap handle 20 includes a first housing 22 which includes a generally hollow cavity 24. The housing 22 may be in the form of an elongated container made from a transparent material, such as an acrylic material. The acrylic material may be transparent or semi-transparent, and in any event has sufficient transparency to enable a liquid 28 contained within the housing 22 to be visible through the housing 22. The housing 22 is transparent so that the color of the liquid 28 contained in the housing 22 is discernable. Optionally, the material of the housing 22 may be clear, green, amber, or any other desired color. In another embodiment, the color of the housing 22 may correspond to the color of glass used by the manufacturer to package the particular beverage when being dispensed in bottles. The material of the housing 22 may be made of a material that is readily washable and can easily be kept clean and sanitary.

The first housing 22 is formed by any plastic molding process, for example, by blow molding or an injection molding process, to resemble any desired shape. As illustrated in FIGS. 1-5, the first housing 22 may be formed to generally resemble a pilsner glass. Optionally, the housing 22 may be formed to resemble a bottle as may be used for retail sales of the product, or may have a shape resembling a logo or other indicia associated with a particular brand of beverage. In still other embodiments, the first housing 22 may be formed to resemble a beer mug or may be formed in more traditional or ornamental shapes for tap handles.

The first housing 22 is formed with an opening 26 located at one end of the housing 22. The opening 26 is in fluid communication with the cavity 24 within the housing 22, permitting the cavity 24 to be filled, at least in part, by a liquid 28. In one embodiment, the liquid 28 may be the same liquid dispensed by the tap faucet 15. Optionally, the liquid 28 may be clear or a clear liquid such as water or oil that is colored to resemble the beverage being dispensed at the tap faucet 15. The liquid 28 may partly or entirely fill the first housing 22. According to one embodiment, the liquid 28 is added to the cavity 24 up to a suitable level corresponding to the shape of the housing 22, leaving a space at the top of the cavity 24. For example, the tap handle 20 illustrated in FIGS. 1-5 resembles a pilsner glass and a suitable volume of liquid 28 is added to the cavity 24 such that the tap handle 20 resembles a full glass.

A cover 30 is included to seal the opening 26 in the first housing 22 and retain the liquid 28 within the housing 22. The cover 30 may be made from the same material as the first housing 22 and, similarly, may be transparent or semi-transparent, clear, green, amber, or any other desired color corresponding to the housing 22. The cover 30 may alternatively be formed of a different material that the first housing 22, and may or may not have transparent properties. For example, in an embodiment in which floating particles are at the upper portion of the cavity 24, as explained below, the cover 30 may be formed of an opaque material having the same color as the floating particles. The cover 30 may be securely joined with the first housing 22, for example, by vibration, friction, laser, heat, or ultrasonic welding, by adhesive, or by any other manner known to one skilled in the art. Optionally, the cover 30 may be removably connected to the housing 22, for example, by a threaded or snap connection.

Many beverages served from a tap faucet 15 include carbonation, causing bubbles or foam to form in or on the beverage. Consequently, floating particles 34 may also be inserted into the cavity 24 to resemble the bubbles or foam of the dispensed beverage. In one embodiment, the floating particles 34 may be made of a foam material and substantially float on the liquid 28 contained within the cavity 24. Optionally, a portion of the floating particles 34 may be suspended within the liquid 28. In other embodiments, the floating particles 34 may be made of any suitable material and in any suitable shape or size and may be an identifier of the manufacturer or brand name of the beverage dispensed from the tap faucet 15.

The tap handle 20 may also include a second housing 50 contained within the cavity 24 of the first housing 22. According to one embodiment, the second housing 50 is generally cylindrical and tapered corresponding to the form of the first housing 22. A recess 36 may be formed at a first end 38 of the cavity and a complementary tab 54 may extend from a first end 56 of the second housing 50. The tab 55 is inserted into the recess 36 to align the first end 56 of the second housing 50 with respect to the first end 38 of the first housing 22. It can readily be appreciated that the tab 54 and recess 36 may be reversed, such that the tab is on the first housing 22 and the recess is on the second housing 50. The second housing 50 may be centrally positioned within the cavity 24 of the first housing 22. The second housing 50 may further include a receiving member 58 extending from a second end 60 of the housing 50, and the cover 30 includes an engaging member 40 extending into the cavity 24. The engaging member 40 operably connects with the receiving member 58 to align the second end 60 of the second housing 50 to the cover 30. It can readily be appreciated that the engaging member 40 and the receiving member 58 may be reversed, such that the engaging member is on the second housing 50 and the receiving member is on the cover 30. In alternate embodiments, the second housing 50 may be of any suitable shape and be aligned with the first housing 22 in any orientation according to the requirements of the tap handle 20.

The second housing 50 defines a volume 52 which, in a first embodiment, contains air. Inserting the second housing 50 into the first housing 22 reduces the volume of liquid 28 required to fill the cavity 24 and, consequently, reduces the weight of the tap handle 20. The second housing 50 may also be made from an acrylic material similarly to the first housing 22. It is contemplated that the second housing 50 may be transparent to minimize visibility within the liquid 28 or, optionally, it may be opaque and include a design related to, for example, the brand or the manufacturer of the beverage being dispensed. In still other embodiments, objects may be inserted into the volume 52 which may, for example, identify the brand or the manufacturer of the beverage being dispensed. The second housing 50 may be formed by any plastic molding process, for example, by blow molding or an injection molding process, in any desired shape. The second housing 50 may be of unitary construction, if, for example, the volume 52 is to contain air, or of multiple part construction, if, for example, an object or objects are to be inserted into the volume 52.

The tap handle 20 further includes a base 32 configured to operably connect the handle 20 to the tap faucet 15. The base 32 may be made from metal, such as brass or stainless steel, but may be any other suitable material as desired. The base 32 is joined to the first housing 22 for example by an adhesive or a threaded connection, or by any suitable method according to the materials used for each of the base 32 and the first housing 22. Optionally, the base 32 may be integrally molded with the first housing 22. Referring to FIG. 5, the base 32 includes a first mating portion 70 and a second mating portion 80. The first mating portion 70 and the second mating portion 80 may be two separate pieces or may be integrally formed as a single member.

The first mating portion 70 is configured to connect the base 32 to the tap faucet 15. The first mating portion 70 includes an aperture 72, which may include a threaded interior such that the tap handle 20 engages a threaded stud (not shown) extending from the tap faucet 15. The threaded interior may be integral to the surface of the aperture 72 or, optionally a ferrule having a smooth exterior surface and a threaded interior surface may be inserted into the aperture 72.

The second mating portion 80 is configured to connect the base 32 to the first housing 22. A lower surface 82 of the second mating portion 80 is adjacent to the first mating portion 70. An outer surface 84 is connected to the lower surface 82 at a first end 86 and extends away from the first mating portion 70. The outer surface 84 may be generally cylindrical and taper outward as it extends from the first end 86 to a second end 88. The second mating portion 80 may be open at the second end 88 of the outer surface and configured to connect to the first housing 22. A volume 90 may be defined between the first housing 22 and the lower and outer surfaces, 82 and 84 respectively, of the second mating portion 80. Optionally, the second mating portion 80 may be formed from a solid member. It is further contemplated that a lighting element may be included within the volume 90 to emit light into the first housing 22. The lighting element may include, for example, a power source, such as a battery, an illumination source, such as a light-emitting diode (LED), and electrical components to control the LED. Further, the second mating portion 80 may be removably connected to the first housing 22, to provide access to the lighting element.

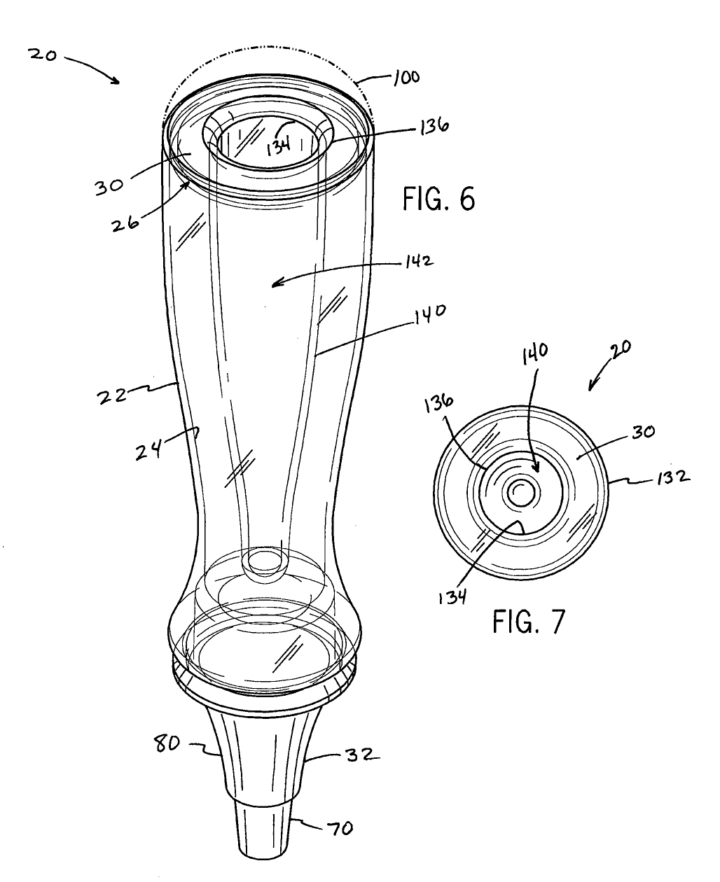

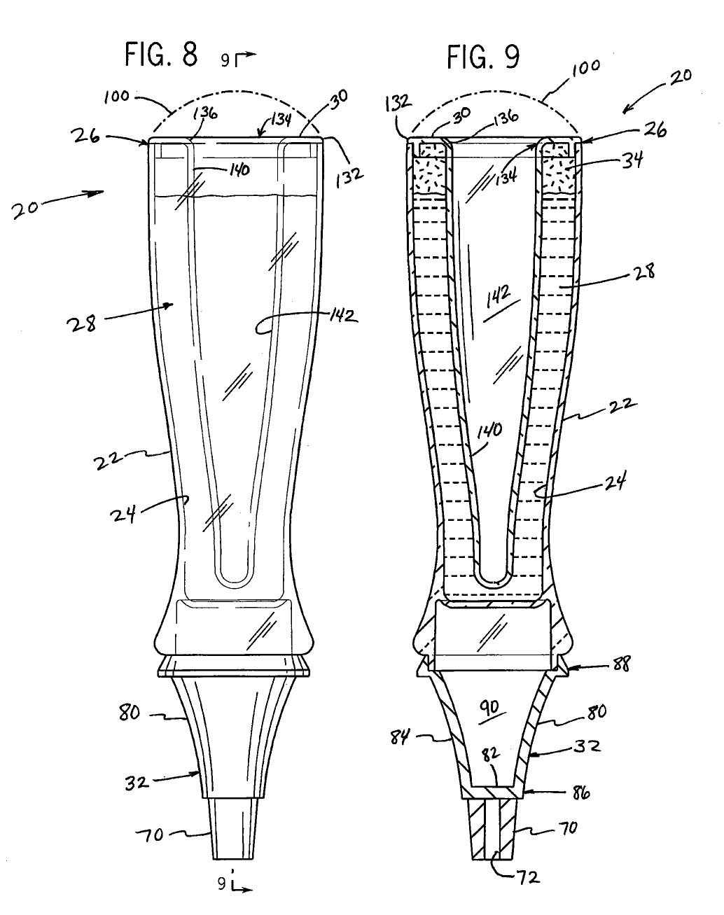

Referring next to FIGS. 6-9, another embodiment of the tap handle 20 similarly includes a first housing 22 with a generally hollow cavity 24. An opening 26 is formed at one end of the housing 22, permitting the cavity 24 to be filled, at least in part, by a liquid 28. Floating particles 34 may also be inserted into the cavity 24 that substantially float on the surface of the liquid 28, remain suspended in the liquid 28, or a combination thereof. The tap handle also includes a cover 30 to seal the opening 26 in the first housing 22.

The cover 30, according to the embodiment illustrated in FIGS. 6-9, is integrally formed with the second housing 140. The outer periphery 132 of the cover 30 is complementary to the opening 26 in the first housing 22, providing a sealing connection to the first housing 22. An opening 134 is formed in the cover 30 , which defines an inner periphery 136 of the cover 30. The inner periphery 136 is connected to the second housing 140 and the cover 30 may be integrally formed with the second housing 140. When the cover 30 is connected to the first housing 22, the second housing 140 extends into the first housing 22. A volume 142 is defined within the second housing 140 and is in communication with the opening 134 in the cover 30. Thus, the volume 142 may be accessible to receive objects inserted therein. The objects may include indicia identifying either the brand or the manufacturer of the beverage dispensed by the faucet 15. Optionally, a cap 100 may be included to cover the opening 134. The cap 100 may be secured to the either the cover 30 or the first housing 22 by vibration, friction, laser, heat, or ultrasonic welding, by adhesive, or by any other manner known to one skilled in the art. Optionally, the cover 30 may be removably connected to the cover 30 or housing 22, for example, by a threaded or snap connection.

The tap handle 20 may further include at least one identifier. The identifier may be a label, a decal, or a symbol or text painted, etched, or integrally formed on the first or second housing, 22 or 50 respectively. The identifier provides to a consumer an indication of the beverage being dispensed by the tap faucet 15 on which the tap handle 20 is connected.

In operation, a tap handle 20 is selected corresponding to a beverage being dispensed by a tap faucet 15. The tap handle 20 is typically secured to the tap faucet 15 by screwing the base 32 of the tap handle 20 to a stud extending from the tap faucet 15. The tap handle 20 is pulled forward to open the faucet 15 and start the flow of the beverage to be dispensed, in a manner as is well known. The tap handle 20 is pushed backwards to close the faucet 15 and stop the flow of the beverage.

The tap handle 20 allows a consumer to readily identify a desired beverage, and also provides a tap handle that can readily be identified by the consumer and distinguished from other tap handles. The first housing 22 may be molded in a shape familiar to the consumer, such as a bottle used to market the product in retail sales or some other shape that a producer may wish to employ in order to identify its product. Each of the first and second housings, 22 and 50 respectively, and the liquid 28 may be colored to resemble the color of the bottle used for retail sales or color of the beverage being dispensed. Alternately, the liquid 28 may be that of the beverage associated with the tap handle.

In addition, identifiers, for example, labels may be applied to the tap handle 20 that resemble the labels used on the bottle for retail sales. The resulting tap handle 20 has the familiar appearance of the packaging used for retail sales, and a consumer may readily identify the beverage being dispensed from the faucet 15. Identifiers may also be included within cavity 24 of the first housing 22 or within the volume 52 defined by the second housing. The identifiers may be objects resembling, for example, animals, logos, or other features indicative of the beverage dispensed from the tap handle 20.

The tap handle 20 also attracts a consumer's attention. As the handle is pulled forward and pushed backwards, the liquid 28 within the tap handle will move within the first housing 22. The motion of the liquid 28 similarly induces motion in the floating particles 34 floating on or suspended within the liquid 28. The motion of the liquid 28 and particles 34 attracts the attention of a consumer. The unique visual impression provided by the liquid within the interior of the tap handle is further enhanced when light is emitted upwardly from the base into the liquid.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention

We claim:

1. A handle for a tap faucet comprising:
a first housing defining a generally hollow cavity and including an opening in communication with the cavity;
a liquid disposed within the hollow cavity;
a cover connected to the first housing to seal the opening; and
a base coupled to the first housing, the base configured to operably connect the first housing to the tap faucet.

2. The handle of claim 1 further comprising a plurality of floating particles disposed within the hollow cavity.

3. The handle of claim 1 further comprising a second housing defining a volume, wherein the second housing is contained within the cavity of the first housing.

4. The handle of claim 3 further comprising an identifier contained within the second housing indicating at least one of the beverage manufacturer or the beverage brand name to be dispensed by the faucet.

5. The handle of claim 3 wherein each of the first and second housings are elongated, the handle further comprising:
a recess and a tab associated with the first end of the cavity in the first housing and the first end of the second housing, the tab configured to engage the recess to retain the second housing in alignment with the first housing.

6. The handle of claim 5 including a receiving member and an engaging member associated with the cover and a second end of the second housing, wherein the engaging member operably engages the receiving member to further retain the second housing in alignment with the first housing.

7. The handle of claim 1 wherein the first housing is at least partly transparent such that the liquid is visible through the housing.

8. The handle of claim 1 wherein the base further comprises:
a first mating portion including an aperture for operably connecting the base to the tap faucet; and
a second mating portion including a lower surface connected to the first mating portion and an outer surface connected at a first end to the lower surface, having a generally open second end, defining a volume within the outer surface, and connected at the second end to the first housing.

9. The handle of claim 8 wherein the first housing is generally translucent and further comprising a light source contained within the volume of the second mating portion and emitting light through the second end into the first housing.

10. The handle of claim 1 wherein the cover engages the opening in the first housing at an outer periphery of the cover and the cover further comprises:
an opening defining an inner periphery of the cover; and
a second housing connected to the inner periphery of the cover, the second housing defining a volume in communication with the opening in the cover and, when the cover is connected to the first housing, extending into the cavity of the first housing.

11. The handle of claim 10 further comprising a cap connected to the outer periphery of the cover and enclosing the opening in the cover.

12. The handle of claim 11 further comprising at least one identifying object positioned within the volume defined by the second housing, the identifying object corresponding to a liquid dispensable from the tap faucet to which the handle is connected.

13. A tap handle adapted to be coupled to a faucet that is fluidly coupled to a beverage source, comprising:
an elongated container defining a volume and having an opening in communication with the volume;
a liquid disposed within the container and constructed to resemble the beverage contained in the beverage source;
a cover to engage the opening in the container; and
a coupler adapted to detachably couple the container to the faucet.

14. The tap handle of claim 13 further comprising a plurality of floating particles disposed within the volume of the container and at least partially floating on the liquid.

15. The tap handle of claim 14 further comprising indicia of at least one of the beverage manufacturer or the beverage brand name affixed to an exterior surface of the container.

16. The handle of claim 14 wherein the elongated container is at least partly transparent such that the liquid and floating particles are visible through the container.

17. The tap handle of claim 16 further comprising an elongated chamber defining a second volume and contained within the volume of the elongated container.

18. The tap handle of claim 17 wherein the elongated chamber includes one of a tab or a receptacle on each end of the chamber configured to engage a complimentary tab or receptacle to orient the chamber within the volume of the container.

19. The tap handle of claim 18 further comprising an identifier contained within the elongated chamber indicating at least one of the beverage manufacturer or beverage brand name to be dispensed by the faucet.

20. The tap handle of claim 14 wherein the elongated container is formed in the shape of a bottle or a drinking container from which the beverage is typically dispensed or consumed, respectively.
